(19) United States
(12) Patent Application Publication
(10) Pub. No.: US 2025/0009174 A1
(43) Pub. Date: Jan. 9, 2025

(54) Air Fryer with Height-Adjustable Rack

(71) Applicant: U Fung Lam, Kowloon Tong (HK)

(72) Inventor: U Fung Lam, Kowloon Tong (HK)

(21) Appl. No.: 18/763,123

(22) Filed: Jul. 3, 2024

(30) Foreign Application Priority Data
Jul. 4, 2023 (HK) 32023075426.1

(51) Int. Cl. A47J 37/06

(52) U.S. Cl. CPC A47J 37/0641

(57) ABSTRACT

In an air fryer, a container fixed to a closure forms a drawer assembly that slides in and out of an opening extending laterally through a housing of the air fryer into the cooking chamber, such that the closure can close the opening. A height-adjustment mechanism includes an operator member adapted to be grasped by a user for raising and lowering a slider assembly that is received in a guideway in the closure and attachable to an internal rack or tray that supports the food to be cooked and which can thereby be raised or lowered between positions where it is otherwise secured by a detent.

### TECHNICAL FIELD

The present invention relates to ovens of the air fryer type that use a high-velocity current of hot air to rapidly cook food and, particularly to an air fryer with a drawer-type cooking chamber holding a height-adjustable rack.

### BACKGROUND OF THE INVENTION

Air fryers are forced convection ovens in which hot air is impelled by a fan around and through the food at a relatively high speed, allowing it to be cooked using much less oil than is needed for deep frying, or even using no oil at all. A common configuration in an air fryer is to provide a drawer, with a closed base and upstanding sidewalls, that bounds a cooking chamber, and which is configured to slide laterally into an opening in the oven housing, whereby the drawer closes the opening.

A rack disposed in the cooking chamber provides a member that supports the food and is open to air flow, promoting air circulation through the food. By adjusting the height of the rack, it is possible, for instance, to vary the distance between the food on the rack and a heating element, or to raise the food to provide easier access during cooking. However, there a number of problems to address in providing such height-adjustability. Domestic air fryers may be small benchtop appliances, so any solution should make efficient use of the available space. In particular, the peripheral edges of the rack are close to the upstanding sidewalls, so any large part projecting inwardly from the sidewalls would prevent the rack being moved vertically, while also reducing the size of the cooking chamber. The height adjustment should also be able to be achieved safely when the cooking chamber is a high temperature. It is an object of the present invention to address these problems or, more generally, to provide an improved air fryer.

### DISCLOSURE OF THE INVENTION

According to one aspect of the present invention there is provided an air fryer comprising:
a housing enclosing a cooking chamber;
an opening that extends laterally through the housing to the cooking chamber;
a drawer assembly comprising:
   a container having a closed base, with upstanding sidewalls surrounding the base, the container configured to slide laterally through the opening into the cooking chamber;
   a closure fixed to the container, whereby with the container in the cooking chamber the closure closes the opening;
   an upright slot in the closure, and an air seal that seals the upright slot;
   at least one guideway in the closure, the guideway extending in upright alignment;
   at least one slider assembly in the closure, the slider assembly comprising a guide member received in the guideway such that the slider assembly is restrained to reciprocate along the guideway, and wherein the guide member projects inwardly through the air seal and the slot into the container;
   a rack adapted to be received in the container to support the food to be cooked, the rack comprising at least one coupler;
   a coupling on an inner end of the guide member that is complementary to the coupler on the rack, whereby engagement of the coupler and complementary coupling supports the rack;
   an operator member of the slider assembly connected to the guide member and projecting outwardly from the closure, the operator member adapted to be grasped by a user for raising and lowering the slider assembly and attached rack or tray vertically between a lower position and one or more elevated positions, and
   a detent for supporting the slider assembly at each elevated position.

Preferably the drawer assembly further comprises a handle fixed to the closure and projecting outwardly therefrom, the handle adapted for carrying the drawer assembly, wherein the handle is elongated in the upright direction and the second arm passes through, and projects outwardly from, the handle.

Preferably the closure is hollow, comprising an inner shell disposed adjacent the container and an outer shell fixed to the inner shell, wherein the guideway is provided between the inner shell and the outer shell. Optionally the guideway is formed in a boss projecting from, and integral with, one of the inner shell and the outer shell. Alternatively the guideway is a member mounted between the inner shell and the outer shell.

Preferably the at least one guideway comprises a pair of guideways, the guideways being parallel and each guideway engaged with a respective guide of the slider assembly.

Optionally, the detent comprises respective abutment members resiliently urged into the guideways to their extended positions in which they abut the respective guides for supporting the slider assembly at the at least one elevated position, the abutments members being displaceable from the guideways to allow the slider assembly to be lowered.

Preferably the pair of parallel guideways further comprises a third guideway disposed between the pair of parallel guideways, each guideway engaged with a respective guide fixed to the slider assembly, and the at least one guide comprises a pair of guides, each fixed to the slider assembly and projecting inwardly through a respective air seal and slot into the container.

Preferably each of the guideways is formed in a respective boss projecting from, and integral with, one of the inner shell and the outer shell.

Preferably the slider assembly comprises a yoke connecting a pair of the guides disposed in the pair of guideways to a third of the guides disposed in the third guideway, wherein axes of the pair of the guides are disposed substantially in a horizontal imaginary plane and an axis of the third of the guides is offset from the imaginary plane.

Preferably the coupling on an inner end of the arm comprises a bracket fixed between the pair of the guides, and the coupler comprises a hook portion of the rack configured to hook onto the bracket.

Preferably the detent comprises a pair of resilient strips, the abutment members comprising intermediate sections of the resilient strips forming U-shaped projections, the U-shaped projections received in respective notches in the bosses.

Preferably the at least one slider assembly comprises two of said slider assemblies, the at least one guideway comprises two of said guideways aligned parallel to one another, each slider assembly comprising a guide member received in a respective one of the guideways, wherein the operator member is configured to releasably connect the slider assemblies.

Preferably each guide member is mounted to rotate about an axis thereof when received in the respective one of the guideways, each slider assembly further comprises a knob connected to the guide member and projecting outwardly from the closure, wherein the knob, guide member and coupling are mutually secured and rotate together when the knob is manually rotated.

Preferably shaft is supported for axial displacement from a normal position and the air fryer further comprises resilient means that urges the shaft to the normal position.

Preferably the rack comprises a perforated dish and a perforated lid adapted to cooperate to enclose food carried on the rack, the at least one coupler comprises first and second like couplers fixed on opposing sides of the rack and substantially coaxially aligned, and wherein the air fryer further comprises a bracket fixed to one of the sidewalls of the container, the first coupler adapted to engage the coupling on the inner end of the guide member and the second coupler adapted to engage the bracket, whereby to support opposite sides of the rack for rotation.

Preferably the rack comprises a hinge connecting the perforated lid to the perforated dish and a resilient latch for latching the lid closed.

By providing an arm extending outwardly of the enclosure that can be manipulated to adjust the height of the rack, height adjustment can be safely achieved without the need to touch the container, of even while the container is in the oven. Furthermore, the height-adjustment mechanism, being substantially inside the closure, takes up little space. Moreover, the drawer assembly has a simple design which minimizes manufacturing costs.

### BRIEF DESCRIPTION OF THE DRAWINGS

Preferred forms of the present invention will now be described by way of example with reference to the accompanying drawings, wherein:

FIG. 1 is a perspective view of a drawer assembly of a first embodiment of an air fryer according to the invention;

FIG. 2 is a perspective view of a height-adjustment mechanism of the drawer assembly of FIG. 1 from an outer side;

FIG. 3 is an exploded view of the drawer assembly of FIG. 1;

FIG. 4 is a perspective view of an air fryer housing that receives the drawer assembly of FIG. 1;

FIG. 5 is a perspective view of the height-adjustment mechanism of FIG. 2 from an inner side, and with the air seals removed for clarity;

FIG. 6 is a fragmentary section in a horizontal plane through the drawer assembly of FIG. 1;

FIG. 7 is a perspective view of a drawer assembly after removal from a housing of a second embodiment of an air fryer according to the invention;

FIG. 8 is an exploded view showing the slider and guideway of the drawer assembly of FIG. 7;

FIG. 9 is an exploded view of the drawer assembly of FIG. 7;

FIG. 10 is a perspective view of the slider and guideway of the drawer assembly of FIG. 7 assembled together;

FIG. 11 is an exploded view of the slider of FIG. 9, and

FIG. 12 is a fragmentary sectional view in a horizontal plane through the slider of the drawer assembly of FIG. 7.

### DESCRIPTION OF THE PREFERRED EMBODIMENTS

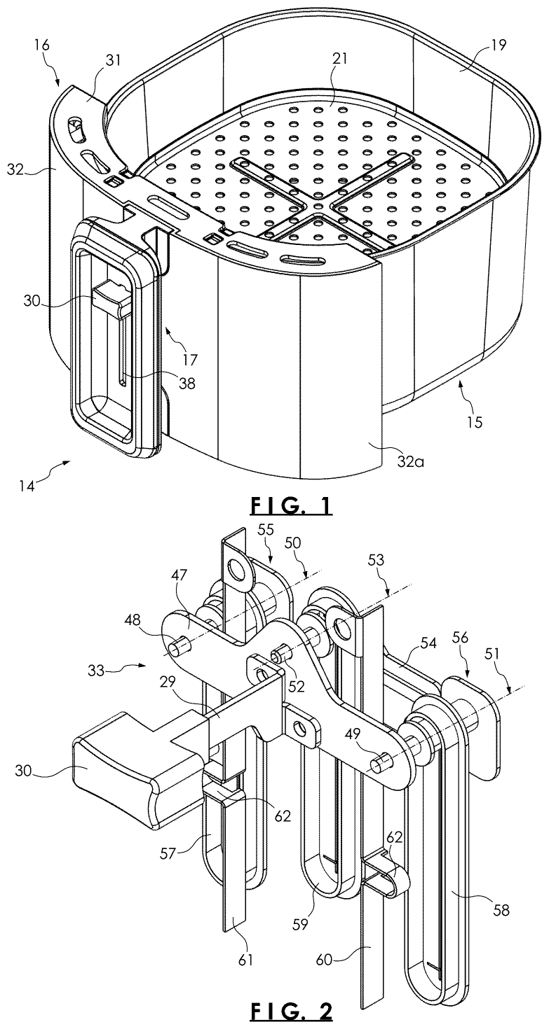

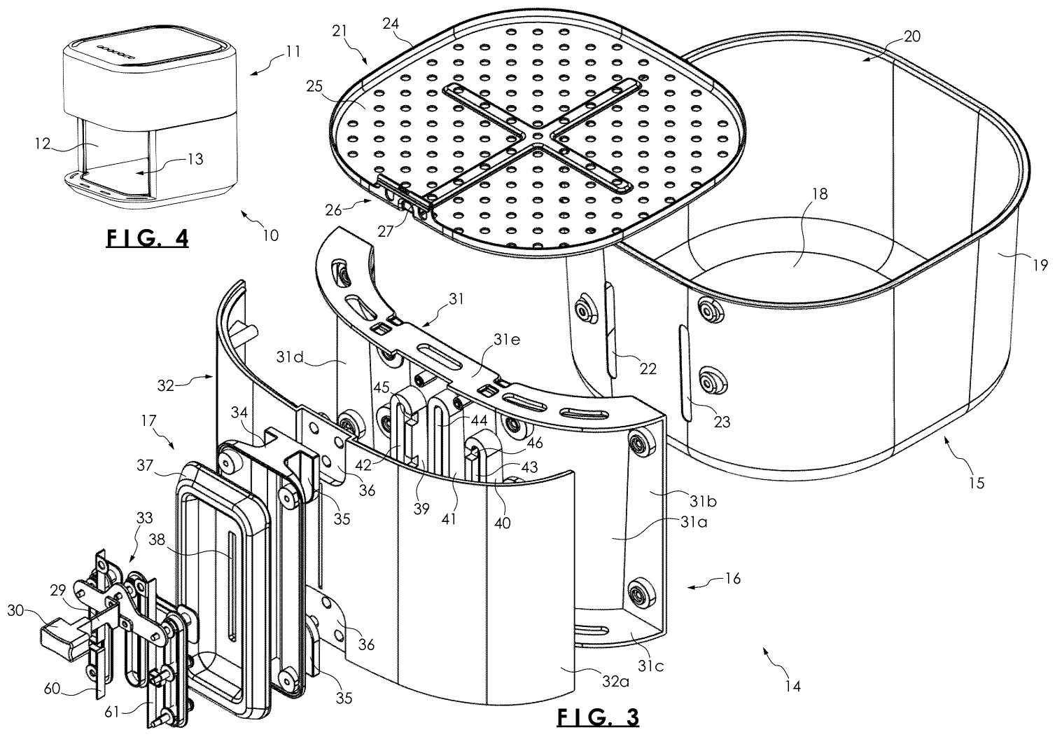

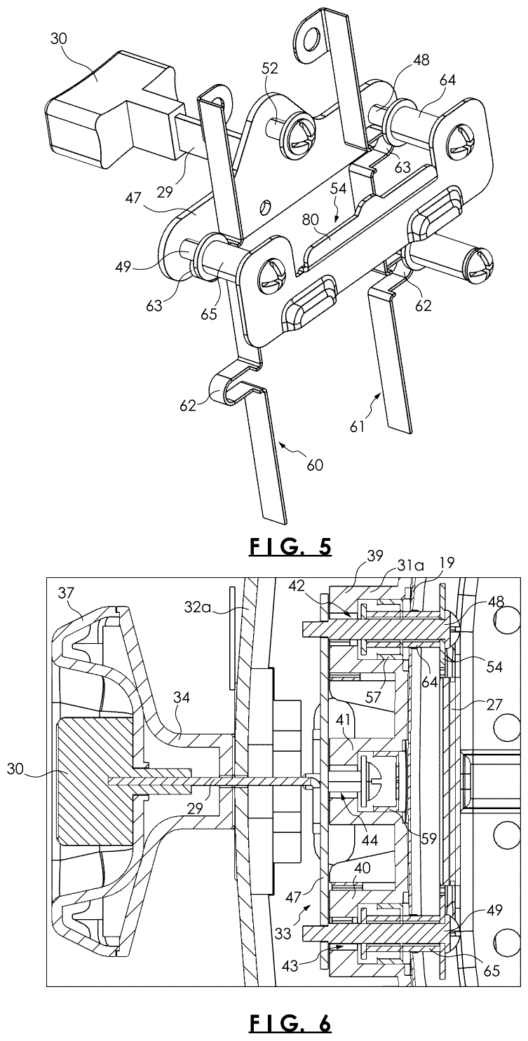

Referring to FIGS. 1 to 4, the air fryer 10 may be an electric kitchen appliance of the benchtop type comprising a housing 11 of an approximately rectangular prismatic form. A cooking chamber 12 enclosed by the housing 11 has a lateral cooking chamber opening 13 through which food (not shown) on its way to or from the air fryer 10 is passed. A drawer assembly, or drawer 14 may include an open-topped container part 15 fixed to a closure 16 having a handle 17, such that the closure 16 closes the opening 13 to the cooking chamber 12. Hot air is circulated through the open top of the container part 15 by fan (not shown) drive, at a variable speed corresponding to a cooking mode, by a rotary motor (not shown).

The container 15 comprises a base 18, with continuous upstanding sidewalls 19 surrounding the base 18. The container 15 may have an open top 20 through which a container, such as rack 21 for supporting the food, may be inserted. The open top 20 also provides for the passage of a stream of hot air is directed down into the container 15 during operation. The base 18 and sidewalls 19 may be generally closed or imperforate, except for parallel upright slots 22, 23 in the sidewalls 19 generally at a front side of the container 15. The rack 21 has periphery of complementary shape to the sidewalls 19 inside which it is received, and may include a peripheral rib 24 raised above a floor 25 that is generally planar and foraminous. Formed on the front side of the rack 21, a coupler 26 may be integral with the rib 24 and comprise a lip 27 that is turned down to form a hook, or inverted U-shape that defines a downwardly-facing recess between the rib 24 and lip 27.

The handle 17 may comprise an elongate member 34 disposed upright and fixed near its ends to the closure 16, as with flanges 35 on opposite ends of the elongate member 34 received in pockets 36 recessed in the outer shell 32. A recess may be provided between the ends of the member 34 for receiving the user's fingers. A cap 37 may cover the outer face of the member 34 and include an upright slit 38 through which the arm 29 extends.

The closure 16 is hollow and an assembly comprising an inner shell 31 disposed adjacent the container 15 and an outer shell 32 fixed to the inner shell 31, as by screw fasteners (not shown). Major wall 31a of the inner shell 31 is spaced from, and follows like curvature to, the major wall 32a of the outer shell 32, thus forming a double-wall which encloses a reciprocating slider 33 of the height-adjustment mechanism 28. The inner shell 31 may include edge walls 31b, 31c, 31d, 31e projecting outwardly from major wall 31a and which enclose the edges of the internal hollow space. The inner shell 31 may further include integral bosses 39, 40, 41 projecting outwardly from major wall 31a. The bosses 39, 40, 41 may be of obround form, each defining a parallel guideways 42, 43, 44 that are upright and extend through the inner shell 31. The guideways 42, 43, 44 comprise a pair of guideways 42, 43 between which a third guideway 44 is disposed. Notches 45, 46 in the bosses 39, 40 provide detent-receiving recesses extending transversely into the pair of guideways 42, 43. A slider assembly 33 is slidably mounted to reciprocate vertically in the guideways 42, 43, 44 to raises and lowers the rack 21. The slider assembly 33 includes an operator member 30 at its outer end that is grasped manually for actuation. The slider assembly 33 may comprise an arm 29 that may project outwardly from the handle 17 and a yoke 47 to which the inner end of the arm 29 is fixed, generally near its centre. A pair of guides 48, 49 may be fixed at opposite ends of the yoke 47, extending parallel to one another, with their axes 50, 51 lying in an imaginary horizontal plane, such that the pair of guides 48, 49 project inwardly from the guideways 42, 43 and through the slots 22, 23 into the container 15.

A third guide 52 may fixed to the yoke 47 centrally between its ends and slidably disposed in the third guideway 44. The third guide 52 does not project inwardly beyond the third guideway 44 and serves to stabilize the slider assembly 33 against the moment load provided by food supported by the cantilevered rack. The third guide 52 is thus offset from the imaginary plane, as by being disposed above the guides 48, 49 with its axis 53 spaced from the imaginary plane of the axes 50, 51. A coupling 54 disposed in the container 15 is fixed to the inner ends 55, 56 of both of the guides 48, and is complementary to the coupler 26 of the rack 21. The pair of guides 48, 49 thus serve the dual function of guiding the slider assembly 33 to reciprocate vertically, while providing the member extending into the container to transmit the load therefrom. As shown, the guides 48, 49, 52 may comprise screw fasteners, with sleeves 64, 65 that extend around the outer ends of the guides 48, 49.

Also fixed in the closure 16, on the inner side of the bosses 39, 40, 41 in the inner shell 31 are elongate air seals 57, 58 that seal the guideways 42, 43 and around the guides 48, 49. A further air seal 59 is fixed in and closes the inner side of the third guideway 44.

A detent mechanism comprises a pair of strips 60, 61 of resilient material such as spring steel. The strips 60, 61 are of like elongate form, arranged generally upright, and may have two sections comprising U-shaped projections that form abutment members 62, 63 received in the notches 45, 46 and projecting into the guideways 42, 43 where they abut the guides 48, 49 at two different predefined heights, where they serve to hold the rack 21 at a predefined height. The strips 60, 61 are able to support the weight of the loaded rack, but with manual assistance, the user can push the guides 48, 49 down past the abutment members 62, 63 which are deflected out of the guideways to permit the guides 48, 49 to pass. In the drawings, the rack 21 is shown at its topmost position, in which the guides 48, 49 rest upon the uppermost abutment members 63.

The coupling 54 comprises a projecting flange 80 disposed between the pair of the guides 48, 49, and which is complementary to the downwardly-facing recess between the rib 24 and lip 27 defined in the coupler 26 and into which projecting flange 80 is received to make the coupling.

In use, the height of the rack 21 is manually adjusted via the operator member 30 between three positions, comprising a lowermost position (not shown) an intermediate position where the members 63 support the rack 21 (not shown) and the topmost position shown.

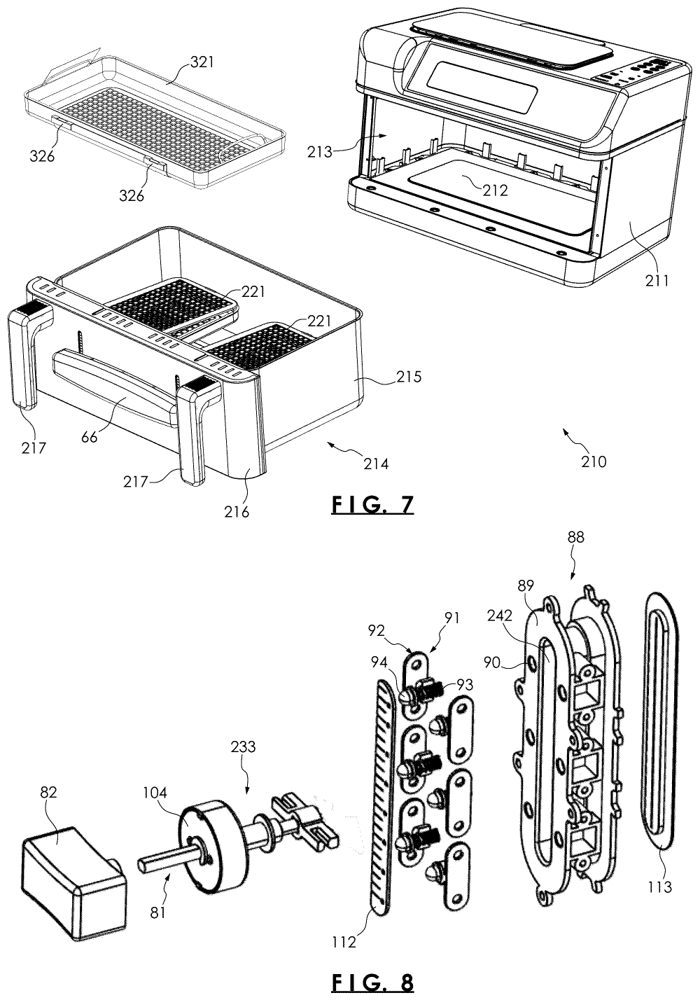

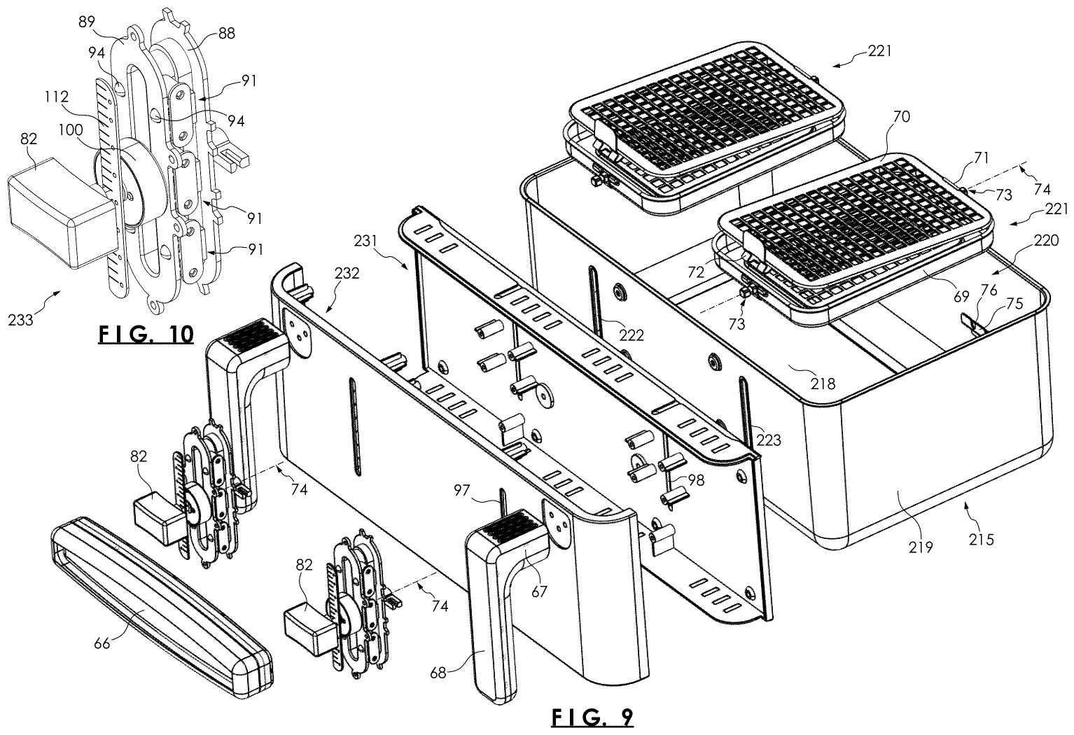

A second embodiment of the air fryer 210 and its components are shown in FIGS. 7 to 11. Referring to FIG. 7, like the first embodiment the air fryer 210 comprises two main sub-assemblies: the drawer 214 and the housing 211. The drawer 214 comprises an open-topped container part 215 that is received in the cooking chamber 212, in which position the closure 216 that is fixed to the container 215 serves to close the opening 213 in the housing 211. The drawer 214 may comprise two handles 217 near opposite ends of the closure 216 by which the drawer 214 may be opened and closed, and lifted. The handles 217 be may comprise two leg parts 67, 68, one leg part 67 fixed at one end to the closure 216, while the other leg part 68 projects down therefrom so as to provide a generally upright grip set outward of the closure 216. Positioned between the handles 217 is an operator member 66 that is elongate and aligned horizontally and by is raised and lowered by the user to adjust the height of a rack 321, or of two racks 221.

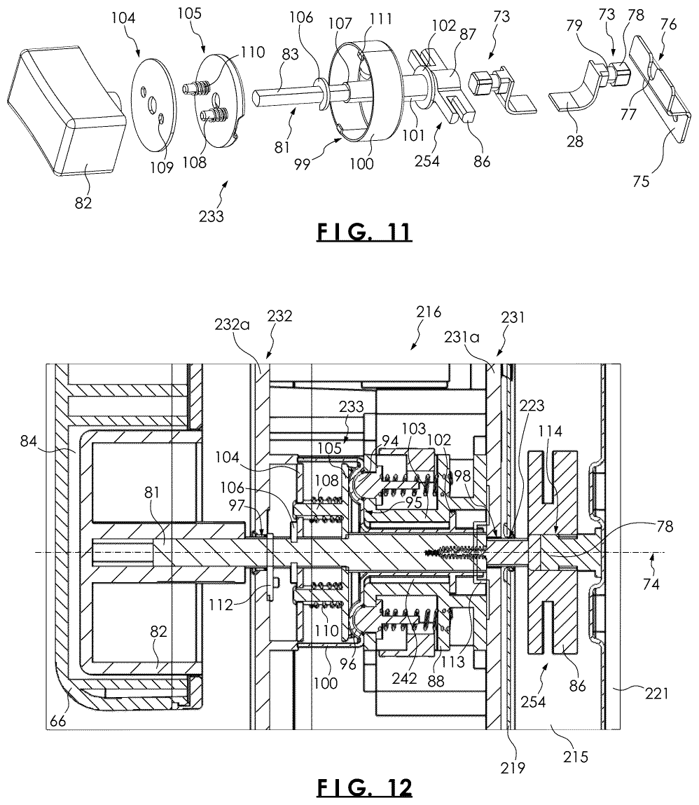

The racks 221 are alike, and adapted for foods such as French fries, chicken etc. For other foods, as of a more delicate type, such as baked goods, the rack 321 with a pair of couplers 326, each complementary to the coupling 254, may be used. Each rack 221 may comprise a perforated dish 69 to which a perforated lid 70 is fixed by a hinge 71 for enclosing the food supported thereon, while being open to the stream of hot air generated by the air fryer 210. Fixed on the lid 70 opposite the hinge 71 may be a resilient latch 72 that can engage the perforated dish 69 to hold the lid 70 closed. Couplers 73 may be in the form of nubs fixed to project from longitudinally opposing ends of the perforated dish 69. The couplers 73 may be coaxial with a central longitudinal axis 74 that bisects the rack 221. Brackets 75 with upwardly-opening recesses 76 may be fixed to inner ones of the sidewalls 219 at an intermediate height and opposite to the slots 222, 223 to engage the outer ones of the couplers 73. The couplers 73 may each terminate in a square head 78 disposed adjacent a circular neck 79, with the recess 76 having a curved base 77 complementary to the circular neck 79 that may be received therein. Outer ones of the couplers 73 of the two racks 221 are supported in the slider assembly 233. Note that in FIG. 11, for clarity, the components of the rack 221 are omitted, except for the couplers 73 which each include a curved leg 28 that is fixed to the perforated dish 69, as by welding.

Like slider assemblies 233 allow a rack 221 supported by both slider assemblies 233 to be raised and lowered during cooking without opening the air fryer 210. Furthermore, this embodiment also advantageously allows internal racks 221 that are each supported by a respective one of the slider assemblies 233 to be raised and lowered independently of one another, as well allowing the racks 221 to be rotated by the user as desired. This rotation assists in turning and/or redistributing food held in the racks 221 during cooking, without the need to open the air fryer 210 and the associated heat loss. The slider assemblies 233 comprise a shaft 81 coaxial with axis 74 and mounted to slide up and down in the closure 216. At the outer end of the shaft 81 is fixed a knob 82 for manipulation by the user. Flats 83 on the shaft 81 may engage complementary flats (not shown) in a blind recess in the knob 82, ensuring that the knob 82 and shaft 81 rotate together. The knob 82 may have a form generally symmetrical about the axis 82, such as a generally rectangular prismatic form, with the operator member 66 having a complementary recess 84 in which the knob 82 may be held, as by a snap fit. In this manner, the operator member 66 may be connected to unite the slider assemblies 233 to move together. Fixed at its inner end, as by a screw joint, the shaft 81 may comprise a coupling 254 disposed inside the outermost of the walls 219 and which may have diametrically opposing wings 85 of like form with slotted tips, and which project from a hub 87. A recess 114 in the inner end of the hub 87 is complementary to the square heads 78 of the racks 221 that may be removably received therein. When connected in this manner, the racks 221 thereby rotate with the shaft 81. The shaft 221 is also mounted, as described below, so that it can be displaced axially outwardly from a normal position toward which it is urged resiliently and this makes proper connection of the racks 221 easier.

The closure 216 is hollow and an assembly comprising an inner shell 231 disposed adjacent the container 215 and an outer shell 232 fixed to the inner shell 231, as by screw fasteners (not shown). Major wall 231a of the inner shell 231 is spaced from the major wall 232a of the outer shell 232, thus forming a double-wall which encloses the slider assembly 233.

Guide members 88 may be fixed between the shells 231, 232, with the two guide members 88 defining guideways 242 that are preferably upright and in registration with slots 97, 98 in the inner and outer shells respectively, through which the shaft 81 extends. The guide members 88 may comprise a face 89 that is planar and surrounds the guideway 242, with a rectangular 2×3 array of apertures 90 in the face. Associated with each aperture 90 is a detent 91 comprising a pin 94, as with a hemispherical tip, slidaby supported on a mount 92 and acted on by a spring 93. The pins 94 are urged to project from the face 89 which engages a planar face 95 of the slider assembly 233. The detents 91 engage recesses 96 in the planar face 95 to hold the slider assembly 233 at one of the heights defined thereby.

The slider assembly 233 is shown separately in FIG. 10 and may comprise a sleeve 99 in which the planar face 95 is provided at a shoulder between a large-diameter portion 100 and a small-diameter portion 101 that is elongate and receives and supports a complementary length of the shaft 81. An annular flange 102 outwardly projecting from the small-diameter portion 101 may cooperate with the planar face 95, such that internal ribs 103 in opposite sides of the guideway 242 are slidingly received between the planar face 95 and the annular flange 102. In this manner, the sleeve 99 supports the shaft 81 for rotation about axis 74 and for sliding vertical translation.

Outer and inner rings 104 and 105 may be received in the large-diameter portion 100 with their central openings receiving the shaft 81 in a running fix and axially disposed between a circlip 106 fixed on the shaft 81 and a shoulder 107 in the shaft 81. These non-rotating rings 104, 105 may include a pair of axially-aligned pins 108 in one that are slidingly received in openings 109 in the other, with springs 110 with opposite ends engaging each of the rings 104, 105 and urging them apart. Tabs 111 at the outer axial end of the large-diameter portion 100 are, after assembly, bent over to the position shown, in which they serve to hold the rings 104, 105 captive in the large-diameter portion 100. FIG. 12 shows the normal position of the shaft 81. As by abutting the coupling 254 with one end of the rack 221, the coupling and shaft 81 can be displaced axially outwardly, the inner ring 105 moving axially with the shaft 81 while the captive outer ring 104 cannot move radially the springs 110 are compressed. When released, the springs 110 urge the shaft 81 and coupling 254 back to the normal position.

An air seal 112 seals the slot 97 and an air seal 113 seals the slot 98 while accommodating the vertical passage of the shaft 81 through the closure 216.

In use, the first task is to choose a desired container according to the food to be prepared and the proposed cooking method. For instance, for preparing French fries, a user may select two racks 221. With the operator member 66 connected to unite the slider assemblies 233 to move together, by grasping and lifting the operator member 66, the slider assemblies 233 are moved together to their intermediate positions (as shown) where both couplings 254 are conveniently positioned for access and in which the sliders 233 are held by the intermediate ones of the detents 91. Each rack 221 is then fixed in the same way, firstly by entering one of its couplers 73 into the recess 114, by pressing the shaft 81 outwardly relative to the container 215 the rack 221 can then by rotated to a horizontal position, while keeping the other of the couplers 73 clear of the adjacent sidewall and before entering the circular neck 79 into the recess 76. The springs 108 urge the coupling 254 axially inward to this position in which the circular neck 79 is received in the curved base 77, thus supporting opposite sides of the rack 221. The drawer 214 is inserted for pre-heating, before being removed to place the French fries in the racks 221, latching the lids 70 closed, and returning the drawer 214 to the oven. If it is desired to agitate the French fries, this can advantageously be done without the need to open the drawer 214 and the associated loss of heat. The user must first disconnect the slider assemblies 233 by disconnecting each of the knobs 82 from the operator member 66. Once exposed in this way, the knobs 82 may be grasped individually and turned, thereby rotating the respective one of the racks 221, which at this intermediate height are free to rotate completely. The knobs 82 may also be raised to lift the appended racks 221 to their uppermost positions (not shown) in which that are held by the uppermost pair of the detents. Indicia (not shown) on the knobs 82 show the proper alignment for ensuring that the racks 221 are upright before the operator member 66 is reattached to hold the racks 221 horizontal and upright.

Aspects of the present invention have been described by way of example only and it should be appreciated that modifications and additions may be made thereto without departing from the scope thereof.

The invention claimed is:

1. An air fryer comprising:
a housing enclosing a cooking chamber;
an opening that extends laterally through the housing to the cooking chamber;
a drawer assembly comprising:
a container having a closed base, with upstanding sidewalls surrounding the base, the container configured to slide laterally through the opening into the cooking chamber;
a closure fixed to the container, whereby with the container in the cooking chamber the closure closes the opening;
an upright slot in the closure, and an air seal that seals the upright slot;
at least one guideway in the closure, the guideway extending in upright alignment;
at least one slider assembly in the closure, the slider assembly comprising a guide member received in the guideway such that the slider assembly is restrained to reciprocate along the guideway, and wherein the guide member projects inwardly through the air seal and the slot into the container;
a rack adapted to be received in the container to support the food to be cooked, the rack comprising at least one coupler;
a coupling on an inner end of the guide member that is complementary to the coupler on the rack, whereby engagement of the coupler and complementary coupling supports the rack;
an operator member of the slider assembly connected to the guide member and projecting outwardly from the closure, the operator member adapted to be grasped by a user for raising and lowering the slider assembly and attached rack or tray vertically between a lower position and one or more elevated positions, and
a detent for supporting the slider assembly at each elevated position.

2. The air fryer of claim 1 wherein the drawer assembly further comprises a handle fixed to the closure and projecting outwardly therefrom, the handle adapted for carrying the drawer assembly, wherein the handle is elongated in the upright direction and the second arm passes through, and projects outwardly from, the handle.

3. The air fryer of claim 1 wherein the closure is hollow, comprising an inner shell disposed adjacent the container and an outer shell fixed to the inner shell, wherein the guideway is formed in a boss projecting from, and integral with, one of the inner shell and the outer shell.

4. The air fryer of claim 1 wherein the at least one guideway comprises a pair of guideways, the guideways being parallel and each guideway engaged with a respective guide fixed to the slider assembly, and the detent comprises respective abutment members resiliently urged into the guideways to their extended positions in which they abut the respective guides for supporting the slider assembly at the at least one elevated position, the abutments members being displaceable from the guideways to allow the slider assembly to be lowered.

5. The air fryer of claim 1 wherein the at least one guideway comprises a third guideway disposed between the pair of parallel guideways, each guideway engaged with a respective guide fixed to the slider assembly, and the at least one guide comprises a pair of guides, each fixed to the slider assembly and projecting inwardly through a respective seal and slot into the container.

6. The air fryer of claim 4 wherein each of the guideways is formed in a respective boss projecting from, and integral with, one of the inner shell and the outer shell.

7. The air fryer of claim 1 wherein the slider assembly comprises a yoke connecting a pair of the guides disposed in the pair of guideways to a third of the guides disposed in the third guideway, wherein axes of the pair of the guides are disposed substantially in a horizontal imaginary plane and an axis of the third of the guides is offset from the imaginary plane.

8. The air fryer of claim 7 wherein the coupling on an inner end of the arm comprises a bracket fixed between the pair of the guides, and the coupler comprises a hook portion of the rack configured to hook onto the bracket.

9. The air fryer of claim 1 wherein the detent comprises a pair of resilient strips, the abutment members comprising intermediate sections of the resilient strips forming U-shaped projections, the U-shaped projections received in respective notches in the bosses.

10. The air fryer of claim 1 wherein the at least one slider assembly comprises two of said slider assemblies, the at least one guideway comprises two of said guideways aligned parallel to one another, each slider assembly comprising a guide member received in a respective one of the guideways, wherein the operator member is configured to releasably connect the slider assemblies.

11. The air fryer of claim 10 wherein each guide member is mounted to rotate about an axis thereof when received in the respective one of the guideways, each slider assembly further comprises a knob connected to the guide member and projecting outwardly from the closure, wherein the knob, guide member and coupling are mutually secured and rotate together when the knob is manually rotated.

12. The air fryer of claim 11 wherein the shaft is supported for axial displacement from a normal position and the air fryer further comprises resilient means that urges the shaft to the normal position.

13. The air fryer of claim 10 wherein the rack comprises a perforated dish and a perforated lid adapted to cooperate to enclose food carried on the rack, the at least one coupler comprises first and second like couplers fixed on opposing sides of the rack and substantially coaxially aligned, and wherein the air fryer further comprises a bracket fixed to one of the sidewalls of the container, the first coupler adapted to engage the coupling on the inner end of the guide member and the second coupler adapted to engage the bracket, whereby to support opposite sides of the rack for rotation.

14. The air fryer of claim 10 wherein the rack comprises a hinge connecting the perforated lid to the perforated dish and a resilient latch for latching the lid closed.

15. The air fryer of claim 10 wherein each guide member is mounted to rotate about an axis thereof when received in the respective one of the guideways, each slider assembly further comprises a knob connected to the guide member and projecting outwardly from the closure, wherein the knob, guide member and coupling are mutually secured and rotate together when the knob is manually rotated, the shaft is supported for axial displacement from a normal position and the air fryer further comprises resilient means that urges the shaft to the normal position, the rack comprises a perforated dish and a perforated lid adapted to cooperate to enclose food carried on the rack, the at least one coupler comprises first and second like couplers fixed on opposing sides of the rack and substantially coaxially aligned, and the air fryer further comprises a bracket fixed to one of the sidewalls of the container, the first coupler adapted to engage the coupling on the inner end of the guide member and the second coupler adapted to engage the bracket, whereby to support opposite sides of the rack for rotation, the rack comprises a hinge connecting the perforated lid to the perforated dish and a resilient latch for latching the lid closed.
